(19) United States
(12) Patent Application Publication
(10) Pub. No.: US 2026/0324931 A1
(43) Pub. Date: Oct. 22, 2026

(54) METHOD OF RE-CLEANING AND CLEANING ROBOT

(71) Applicant: SHENZHEN SILVER STAR INTELLIGENT GROUP CO., LTD., SHENZHEN (CN)

(72) Inventors: Meng Li, SHENZHEN (CN); Guoyan Tan, SHENZHEN (CN); Qian Sun, SHENZHEN (CN); Juanjuan Ren, SHENZHEN (CN); Yue Ban, SHENZHEN (CN); Lirong Ye, SHENZHEN (CN)

(21) Appl. No.: 19/725,128

(22) Filed: Jun. 30, 2026

Related U.S. Application Data
(63) Continuation of application No. 18/349,944, filed on Jul. 10, 2023, now Pat. No. 12,714,278.

(30) Foreign Application Priority Data
Jul. 21, 2022 (CN) 202210873679.X

(51) Int. Cl. A47L 11/40; G05D 1/00

(52) U.S. Cl. CPC A47L 11/4011; A47L 11/4061; G05D 1/2464; G05D 1/6482; A47L 2201/04; A47L 2201/06; G05D 2105/10; G05D 2107/40; G05D 2109/10

(57) ABSTRACT

A method of re-cleaning, applied to a cleaning robot, includes: obtaining a grid map of a target area, wherein the grid map includes at least one primary cleaning partition; based on real-time obstacle information and the grid map, obtaining a target partition; and navigating the cleaning robot to the target partition for cleaning. The target partition is a re-cleaning partition accessible to the cleaning robot. The re-cleaning partition is a primary cleaning partition that is incompletely cleaned.

### CROSS-REFERENCE TO RELATED APPLICATION

The present disclosure is a continuation of U.S. patent application Ser. No. 18/349,944, filed on Jul. 10, 2023, which claims priority of Chinese Patent Application No. 202210873679.X, filed on Jul. 21, 2022, the contents of which are incorporated herein by reference.

### TECHNICAL FIELD

The present disclosure relates to the technical field of smart home, and in particular to a method of re-cleaning and a cleaning robot.

### BACKGROUND

With the development of science and technology, some smart household devices have gradually entered the lives of the public, such as cleaning robots, which can help people reduce the burden of housework and maintain a good living environment.

In related art, cleaning robots are designed to clean a designated area in zones and return to their charging dock, wherein if the cleaning robot encounters obstacles, such as a closed door, a moving person or pet, and a wall of a narrow entrance, during working, it may leave current zone and go to next zone for cleaning. However, the current partition is not yet cleaned completely, and the cleaning robot returns to the position of the charging stand after cleaning of other partitions is completed, so that re-cleaning will not be performed on the partition that has not been cleaned completely, which causes a case that cleaning is missed in part of the area and leads to low cleaning quality.

### SUMMARY

An embodiment of the present disclosure provides a method of re-cleaning, applied to a cleaning robot. The method includes: obtaining a grid map of a target area, wherein the grid map includes at least one primary cleaning partition; based on real-time obstacle information and the grid map, obtaining a target partition; and navigating the cleaning robot to the target partition for cleaning. The target partition is a re-cleaning partition accessible to the cleaning robot. The re-cleaning partition is a primary cleaning partition that is incompletely cleaned.

### BRIEF DESCRIPTION OF DRAWINGS

FIG. 1 is a schematic diagram of an embodiment of a method of re-cleaning according to an embodiment of the present disclosure;

FIG. 2 is a simplified schematic diagram of a grid map according to an embodiment of the present disclosure;

FIG. 3 is a schematic diagram of an embodiment of a grid map partition according to an embodiment of the present disclosure;

FIG. 4 is a schematic diagram of another embodiment of a method of re-cleaning according to an embodiment of the present disclosure;

FIG. 5 is a schematic diagram of a first re-cleaning partition generation scenario according to an embodiment of the present disclosure;

FIG. 6 is a schematic diagram of a second re-cleaning partition generation scenario according to an embodiment of the present disclosure;

FIG. 7 is a schematic diagram of a third re-cleaning partition generation scenario according to an embodiment of the present disclosure;

FIG. 8 is a schematic diagram of a candidate point of a re-cleaning partition according to an embodiment of the present disclosure;

FIG. 9 is a schematic diagram of an area to assist in explaining a cleaning mode according to an embodiment of the present disclosure;

FIG. 10 is a schematic diagram of an embodiment of a second cleaning apparatus according to an embodiment of the present disclosure;

FIG. 11 is a schematic diagram of another embodiment of an apparatus of re-cleaning according to an embodiment of the present disclosure; and

FIG. 12 is a schematic diagram of an embodiment of a cleaning robot according to an embodiment of the present disclosure.

### DETAILED DESCRIPTION

Embodiments of the present disclosure provide a method and an apparatus of re-cleaning, a cleaning robot, and a storage medium, wherein a re-cleaning partition is found according to a re-cleaning conditions, and the cleaning robot navigates to the re-cleaning partition that can be reached and is closest to the cleaning robot for cleaning, so that the cleaning efficiency and the cleaning quality are improved.

In the description, claims, and accompanying drawings of the present disclosure, the terms “first”, “second”, “third”, “fourth”, and so on (if any) are intended to distinguish between similar objects but do not necessarily indicate a specific order or sequence. It should be understood that the data termed in such a way are interchangeable in proper circumstances, so that embodiments described herein can be implemented in other orders than the order illustrated or described herein. Moreover, the terms “include” or “have” and any variant thereof are intended to cover a non-exclusive inclusion. For example, a process, method, system, product, or device that includes a list of steps or units is not necessarily limited to those steps or units that are expressly listed, but may include other steps or units not expressly listed or are inherent to the process, method, product, or device.

For ease of understanding, the following describes a specific process of an embodiment of the present disclosure, and the present disclosure is performed by a cleaning robot, which includes a floor sweeping robot, a floor mopping robot, a vacuuming robot, or other robots with floor cleaning functions.

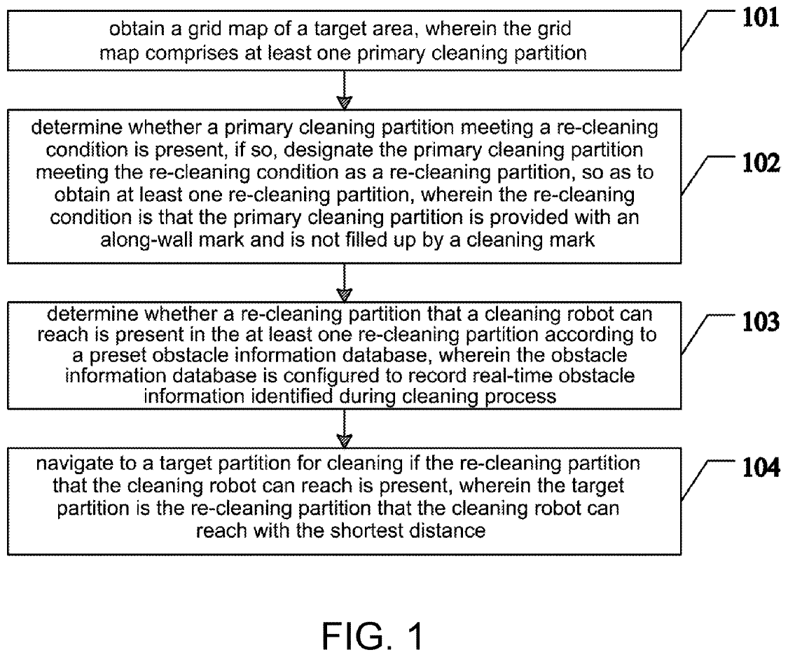

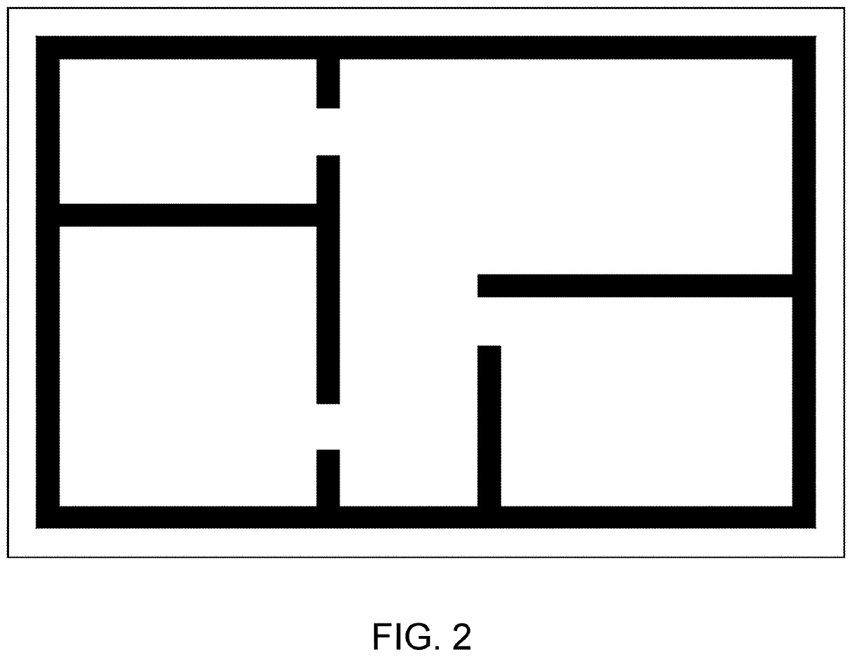

Referring to FIG. 1, an embodiment of a method of re-cleaning according to an embodiment of the present disclosure includes:
101: Obtaining a grid map of a target area, wherein the grid map includes at least one primary cleaning partition;
herein, the grid map is a digitized image established by a cleaning robot based on an indoor real environment during the cleaning process, a minimum unit in the grid map is a grid, and each grid corresponds to one area of the indoor real environment. The cleaning robot gives a gray value to each grid, and whether an actual environment corresponding to the grid is occupied by obstacles is determined according to the gray value, wherein the obstacles include a wall body, an electric appliance cabinet body, and furniture. As shown in FIG. 2, common gray values are 0 and 255, wherein 0 represents black, which is used to indicate that an area is occupied by obstacles, and 255 represents white, which is used to indicate that an area is not occupied by obstacles.

The cleaning robot partitions the unoccupied area in the grid map, and in addition to partitioning according to a room, a partitioning rule is further provided, wherein the cleaning robot identifies unoccupied grids at an uppermost end, a lowermost end, a leftmost end and a rightmost end in the grid map, generates a first horizontal line passing through the uppermost grid and a second horizontal line passing through the lowermost grid, a first vertical line passing through the leftmost grid and a second vertical line passing through the rightmost grid, cuts a closed area surrounded by the first horizontal line, the second horizontal line, the first vertical line and the second vertical line in a transverse direction and in a longitudinal direction, and then obtains a minimum partition as a primary cleaning partition, wherein each primary cleaning partition includes unoccupied grids. In order to avoid a case that the number of the primary cleaning partitions is too large due to the large number of the cuttings, the number of the transverse and longitudinal cuttings can be determined based on actual length and width of the closed area, the closed area is equally divided and cut in length and width dimensions based on the number of the transverse and longitudinal cuttings, and a plurality of primary cleaning partitions are obtained after cutting. A solution for counting the number of cuttings is provided here: M1 and M2 are a length and a width of a closed area, respectively, N1 and N2 are a preset length and width, respectively, M1≥N1, M2≥N2, the number of transverse cuttings K1 of the closed area is taken as an integer part of M1/N1, and the number of longitudinal cuttings K2 of the closed area is taken as an integer part of M2/N2. The desired number of primary cleaning partitions is obtained by this partitioning rule through adjusting the preset length and width values. When a target area is very large and a length of the target area is far larger than a width or a width of the target area is far larger than a length, the target area can be divided into partitions with an appropriate number and size, wherein the appropriate number enables the cleaning robot to more accurately locate a position at which the cleaning robot is positioned when the last cleaning is interrupted during the re-cleaning, which avoids a phenomenon that the cleaned area is cleaned again or the un-cleaned area is not cleaned due to inaccurate positioning; and the appropriate size can avoid a case that the cleaning robot cannot enter due to narrow partitions, improve the positioning accuracy of the cleaning robot, and improve the cleaning quality of the target area. When the length and width of the target area are not greatly different, the preset length and width can be set to be the same or close values, so that the number of transverse cuttings of the target area is equal to the number of longitudinal cuttings of the target area, and the target area is equally divided in length and width dimensions.

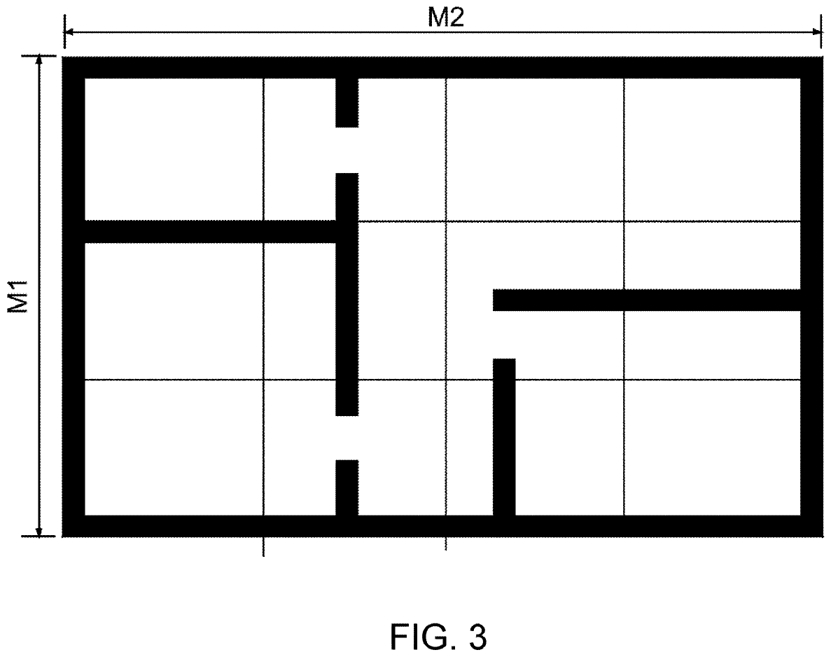

For example, when the length and width of the closed area are 13.2 meters and 10 meters, respectively, and the preset length and width are 5 meters and 3 meters, respectively, M1/N1=2.64, M2/N2=3.33, then K1=2, and K2=3. The closed area is cut 2 times in a length direction, that is, the closed area will be equally divided into 3 parts in the length direction of the closed area; similarly, the closed area is cut 3 times in a width direction of the closed area, that is, the closed area will be equally divided into 4 parts in the width direction of the closed area, and finally the closed area is divided into 12 primary cleaning partitions, as shown in FIG. 3.
102: Determining whether a primary cleaning partition meeting a re-cleaning condition is present, if so, designating the primary cleaning partition meeting the re-cleaning condition as a re-cleaning partition to obtain at least one re-cleaning partition, wherein the re-cleaning condition is that the primary cleaning partition is provided with an along-wall mark and is not filled up by a cleaning mark; and
a cleaning mode of the cleaning robot includes along-edge cleaning and area cleaning. Herein, the along-edge cleaning refers to cleaning along an edge of a primary cleaning partition, and when the cleaning robot performs along-edge cleaning, the along-wall marks are added in the grid map at intervals of a preset time or a preset traveling distance. The area cleaning refers to cleaning in a zigzag path within an area surrounded by markings along the wall, when the cleaning robot performs area cleaning, the cleaning marks are added in the grid map at intervals of preset time or a preset traveling distance. The along-wall marks and the cleaning marks can be marks with two different colors or two different shapes. In each primary cleaning partition, the cleaning robot performs the along-edge cleaning first, followed by the area cleaning.

The cleaning robot scans each primary cleaning partition on the grid map, and if any one of the following three cases occurs in the primary cleaning partition, the primary cleaning partition is designated as a re-cleaning partition:
1) a part of edges of the primary cleaning partition are provided with along-wall marks;
2) all edges of the primary cleaning partition are provided with along-wall marks, however, the primary cleaning partition is not provided with cleaning marks; and
3) all edges of the primary cleaning partition are provided with along-wall marks, and the primary cleaning partition is provided with cleaning marks, however, the primary cleaning partition is not filled with the cleaning marks.

For example, the target area has 5 primary cleaning partitions, wherein only a part of edges of the primary cleaning partition 1 are provided with along-wall marks; all edges of the primary cleaning partition 2 are provided with along-wall marks, and this partition is filled with cleaning marks; all edges of the primary cleaning partition 3 are provided with along-wall marks, however, this partition is not provided with cleaning marks; a part of edges of the primary cleaning partition 4 are provided with along-wall marks, however, this partition is not filled with cleaning marks; and all edges of the primary cleaning partition 5 are provided with along-wall marks, however, this partition is not filled with cleaning marks. Therefore, the primary cleaning partition 1, the primary cleaning partition 3, the primary cleaning partition 4, and the primary cleaning partition 5 are designating as re-cleaning partitions.
103: Determining whether a re-cleaning partition that a cleaning robot can access is present in the at least one re-cleaning partition according to a preset obstacle information database, wherein the obstacle information database is configured to record real-time obstacle information identified during the cleaning process; and
recording the real-time obstacle information detected by the cleaning robot through a laser radar or an infrared sensor during the movement in the obstacle information database, wherein an obstacle is an object appearing at an unoccupied position in a grid map; when the cleaning robot senses the obstacle, determining whether the obstacle has already been recorded in the obstacle information database, if not, obtaining a position of the obstacle, starting a camera to take pictures of the obstacle and the surrounding environment, recording the position of the obstacle, the picture of the obstacle, the picture of the surrounding environment of the obstacle, and a state of the obstacle in the obstacle information database, and setting the state of the obstacle to be “present”; and when the cleaning robot identifies that the obstacle recorded in the obstacle information database is not located at an original position, setting the state of the obstacle to be “absent”.

The cleaning robot obtains a position point of the cleaning robot and a candidate point of each re-cleaning partition that is closest to the cleaning robot, so as to obtain a candidate navigation route to each re-cleaning partition according to the position point and the candidate point of each re-cleaning partition. A preset obstacle information database is invoked, and whether an obstacle is present on each candidate navigation route is inquired. If an obstacle is present on a target candidate navigation route, the cleaning robot cannot reach the re-cleaning partition corresponding to the target candidate navigation route; and if an obstacle is absent on a target candidate navigation route, the cleaning robot can reach the re-cleaning partition corresponding to the target candidate navigation route.

It should be additionally noted that there are three reasons for the re-cleaning partition, the first reason is that a dynamic obstacle is at an entrance; the second reason is that a low obstacle is near the entrance or on the edge, due to the hardware structure, the laser radar cannot identify the low obstacle, and the low obstacle is identified as an occupied area on the grid map, so that the entrance becomes smaller, resulting in the same situation as the third situation; and the third reason is that the entrance is narrow, and a size of the entrance is the same as or slightly larger than a diameter of the cleaning robot, due to a movement control error of the cleaning robot, sometimes the cleaning robot cannot pass through the entrance. When a candidate point of the re-cleaning partition is at an entrance, the cleaning robot reaches the entrance; and when the candidate point of the re-cleaning partition is at a non-entrance, the cleaning robot passes through the entrance, so that a necessary condition for determining whether the cleaning robot can reach the entrance of the re-cleaning partition is that there is no obstacle at the entrance of the re-cleaning partition. If the obstacle is present in the target candidate navigation route but it is not at the entrance, then whether another obstacle-free navigation route is present between the cleaning robot and the target re-cleaning partition corresponding to the target candidate navigation route is determined again, and if so, this obstacle-free navigation route is taken as a new candidate navigation route of the target re-cleaning partition.

For example, the target area has 4 re-cleaning partitions: a re-cleaning partition 1, a re-cleaning partition 2, a re-cleaning partition 3, and a re-cleaning partition 4. The cleaning robot plans navigation routes to 4 re-cleaning partitions to obtain corresponding candidate navigation route 1, candidate navigation route 2, candidate navigation route 3, and candidate navigation route 4. A preset obstacle information database is invoked to inquire whether an obstacle is present on the 4 candidate navigation routes. After inquiry, an obstacle is absent on the candidate navigation route 1 and the candidate navigation route 2, and an obstacle is present on the candidate navigation route 3 and the candidate navigation route 4, however, the obstacle on the candidate navigation route 3 is at an entrance of the re-cleaning partition 3, and the obstacle on the candidate navigation route 4 is not at the entrance of the re-cleaning partition 4. The cleaning robot determines whether an obstacle-free navigation route to the re-cleaning partition 4 is present. After determination, an obstacle-free navigation route 4 is present, and the obstacle-free navigation route 4 is taken as a new candidate navigation route 4. Therefore, the re-cleaning partition 1, the re-cleaning partition 2, and the re-cleaning partition 4 are the re-cleaning partitions that the cleaning robot can reach.
104: If the re-cleaning partition that the cleaning robot can reach is present, the cleaning robot navigates to the target partition for cleaning, wherein the target partition is the re-cleaning partition that the cleaning robot can reach with the shortest distance.

A re-cleaning partition that the cleaning robot can reach is referred to as a reachable re-cleaning partition. The cleaning robot screens a candidate point on each reachable re-cleaning partition that is closest to the cleaning robot, and calculates a distance between each candidate point and the cleaning robot in various modes, such as a Euclidean distance, a navigation distance, or a Manhattan distance. Preferably, the Manhattan distance between each candidate point and the cleaning robot is calculated herein to obtain at least one Manhattan distance. When only one Manhattan distance is present, the reachable re-cleaning partition corresponding to the unique Manhattan distance is taken as a target partition, and the cleaning robot navigates to the target partition for cleaning; when two or more Manhattan distances are present, the reachable re-cleaning partition corresponding to the shortest Manhattan distance is selected as a target partition, and the cleaning robot navigates to the target partition for cleaning.

Two candidate point selection modes are provided, where the first mode is that a cleaning robot is taken as a center, all points on a grid map are scanned by adopting a breadth first search (BFS) algorithm, and the first scanned point belonging to a target reachable re-cleaning partition is taken as a candidate point of the target reachable re-cleaning partition; and the second mode is that the cleaning robot sends sound wave signals or light signals to a target reachable re-cleaning partition for detection, and a point corresponding to the first received feedback signals is taken as a candidate point of the target reachable re-cleaning partition.

In embodiments of the present disclosure, a partition that needs re-cleaning is identified from a primary cleaning partition according to the re-cleaning condition, so that a missed area that has not been cleaned yet is avoided, and a re-cleaning partition that the cleaning robot can reach and is closest to the cleaning robot is selected, so that the cleaning efficiency is improved; and the cleaning robot performs the area cleaning after reaching the re-cleaning partition, so that the cleaning quality of the target area is improved.

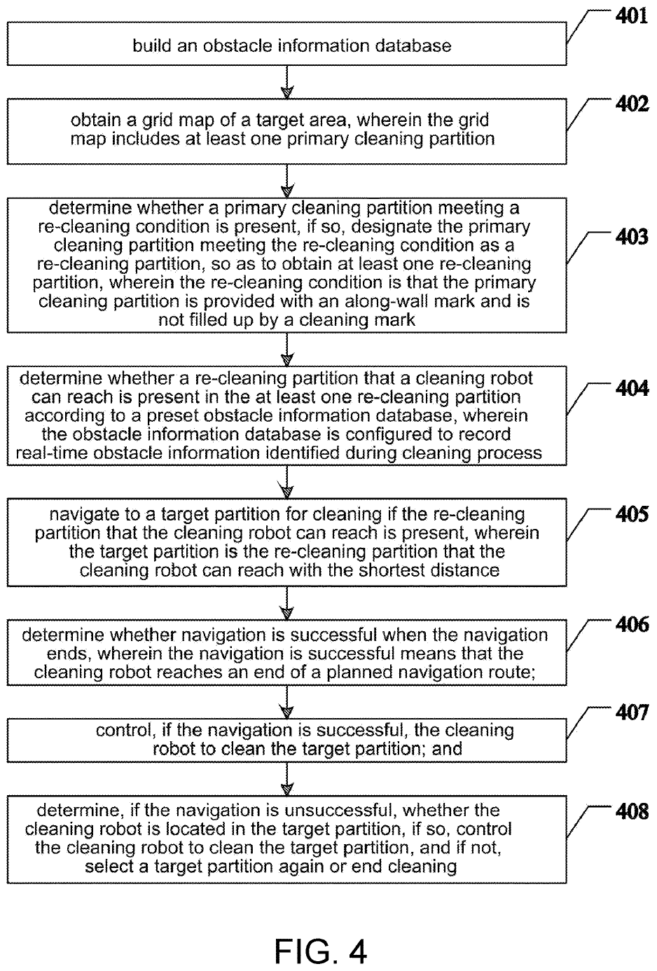

Referring to FIG. 4, another embodiment of a method of re-cleaning according to an embodiment of the present disclosure includes:
401: Building an obstacle information database;
establishing an obstacle information database, wherein the obstacle information database is configured to record real-time obstacle information identified by the cleaning robot during the cleaning process, and the obstacle information includes a position of an obstacle, a picture of an obstacle, a surrounding environment picture of an obstacle, and a state of an obstacle. When the cleaning robot identifies a newly added obstacle, a position of the obstacle is obtained, a camera is started to take pictures of the obstacle and the surrounding environment, a state of the newly added obstacle is set to be “present”, the position of the obstacle, the picture of the obstacle, the picture of the surrounding environment of the obstacle, and the state of the obstacle are recorded in the obstacle information database, and a rule for determining whether an added new obstacle is present is that an obstacle is detected at an unoccupied position in the grid map and the obstacle is not recorded in the obstacle information database. When the cleaning robot identifies that a position of a target obstacle recorded in the obstacle information database has changed, the information of the target obstacle in the obstacle information database is updated, wherein the updated content may be the update of the target obstacle state or the deletion of the target obstacle information, for example, when the cleaning robot identifies that the target obstacle is not located at an original position, the state of the target obstacle may be set to be “absent”, or the information of the target obstacle may be deleted from the obstacle information database.

Furthermore, a fixed obstacle that is misdetermined as a dynamic obstacle is present in the obstacles, for example, newly-added articles with low moving frequency such as cabinets or sofas block part of the room entrance due to the size or space limitation. Therefore, in order to ensure the accuracy of the obstacle information database, it is necessary to track the obstacles identified by the cleaning robot, and add a counter to each obstacle recorded in the obstacle information database, wherein the initial value of the counter is set to 0. The obstacle information database is updated by a sensor during the moving process of the cleaning robot, and the cleaning robot sensor includes a laser radar, an infrared sensor, or a camera. If the obstacle is not located at an original position, the state of the obstacle is set to be “absent”, or the information of the obstacle is deleted. If the obstacle is still located at the original position, the state of the obstacle is kept to be “present”, the counter of the obstacle is added by 1, and each obstacle with a “present” state is monitored. When the value displayed on the counter of the obstacle is greater than a set value, the obstacle is determined as a fixed obstacle, the grid map is updated, and the information of the fixed obstacle in the obstacle information database is deleted.

For example, the set value is 30, the cleaning robot identifies new obstacle A and obstacle B on the first day of cleaning, the states of the two obstacles are set to be “present”, the information of the obstacle A and the information of the obstacle B are recorded in the obstacle information database, and counters with an initial value of 0 are added to the obstacle A and the obstacle B. On the second day of cleaning, the cleaning robot detects that obstacle A is not located at the recorded position, and obstacle B is still located at the recorded position, so that the state of the obstacle A is set to be “absent”, and the counter of the obstacle B is increased by 1. After a period of time, the value on the obstacle B counter is 31, which is greater than the set value, so that the obstacle B is determined as a fixed obstacle, a grid of a position where the obstacle B is located in the grid map is updated into an occupied state, and the information of the obstacle B in the obstacle information database is deleted.
402: Obtaining a grid map of a target area, wherein the grid map includes at least one primary cleaning partition;
herein, the grid map is a digitized image established by a cleaning robot based on an indoor real environment during the cleaning process, a minimum unit in the grid map is a grid, and each grid corresponds to one area of the indoor real environment. The cleaning robot gives a gray value to each grid, and whether an actual environment corresponding to the grid is occupied by obstacles is determined according to the gray value, wherein the obstacles include a wall body, an electric appliance cabinet body, and furniture. For example, the common gray values are 0 and 255, wherein 0 represents black, which is used to indicate that an area is occupied by obstacles, and 255 represents white, which is used to indicate that an area is not occupied by obstacles.

The cleaning robot partitions the unoccupied area in the grid map, and in addition to partitioning according to a room, a partitioning rule is further provided, wherein the cleaning robot identifies unoccupied grids at an uppermost end, a lowermost end, a leftmost end and a rightmost end in the grid map, generates a first horizontal line passing through the uppermost grid and a second horizontal line passing through the lowermost grid, a first vertical line passing through the leftmost grid and a second vertical line passing through the rightmost grid, cuts a closed area surrounded by the first horizontal line, the second horizontal line, the first vertical line and the second vertical line in a transverse direction and in a longitudinal direction, and then obtains a minimum partition as a primary cleaning partition, wherein each primary cleaning partition includes unoccupied grids. In order to avoid a case that the number of the primary cleaning partitions is too large due to the large number of the cuttings, the number of the transverse and longitudinal cuttings can be determined based on actual length and width of the closed area, the closed area is equally divided and cut in length and width dimensions based on the number of the transverse and longitudinal cuttings, and a plurality of primary cleaning partitions are obtained after cutting. A solution for counting the number of cuttings is provided here: M1 and M2 are a length and a width of a closed area, respectively, N1 and N2 are a preset length and width, respectively, M1≥N1, M2≥N2, the number of transverse cuttings K1 of the closed area is taken as an integer part of M1/N1, and the number of longitudinal cuttings K2 of the closed area is taken as an integer part of M2/N2. The desired number of primary cleaning partitions is obtained by this partitioning rule through adjusting the preset length and width values. When a target area is very large and a length of the target area is far larger than a width or a width of the target area is far larger than a length, the target area can be divided into partitions with an appropriate number and size, wherein the appropriate number enables the cleaning robot to more accurately locate a position at which the cleaning robot is positioned when the last cleaning is interrupted during the re-cleaning, which avoids a phenomenon that the cleaned area is cleaned again or the un-cleaned area is not cleaned due to inaccurate positioning; and the appropriate size can avoid a case that the cleaning robot cannot enter due to narrow partitions, improve the positioning accuracy of the cleaning robot, and improve the cleaning quality of the target area. When the length and width of the target area are not greatly different, the preset length and width can be set to be the same or close values, so that the number of transverse cuttings of the target area is equal to the number of longitudinal cuttings of the target area, and the target area is equally divided in length and width dimensions.

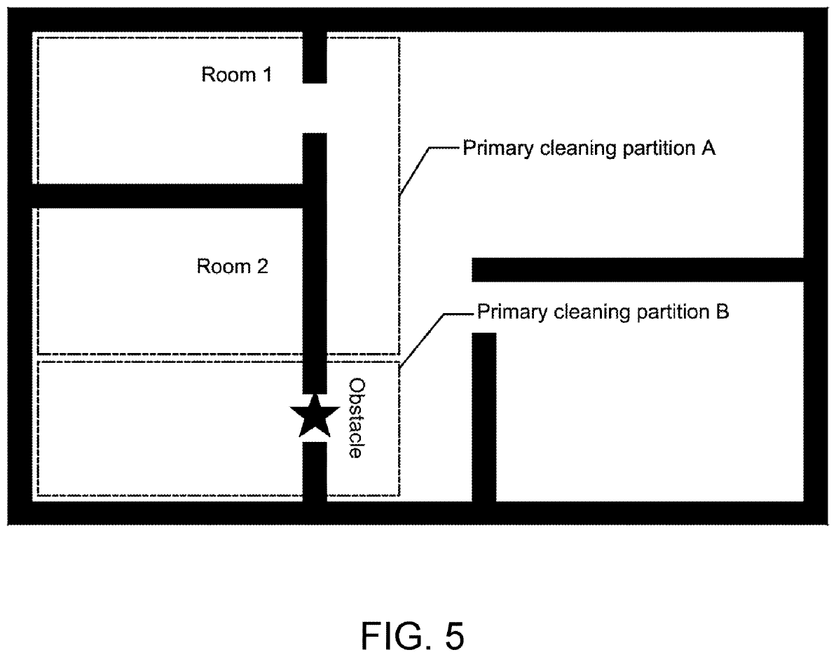

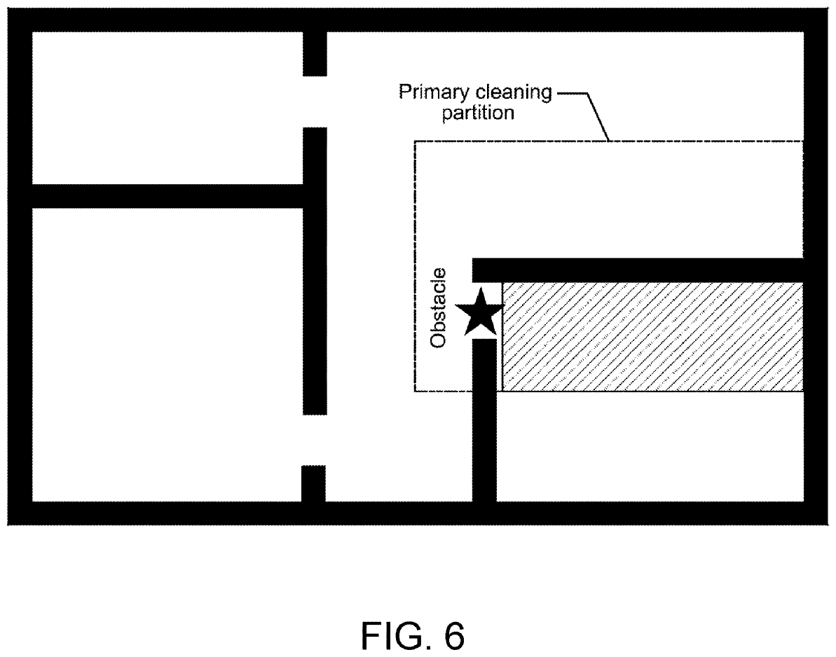

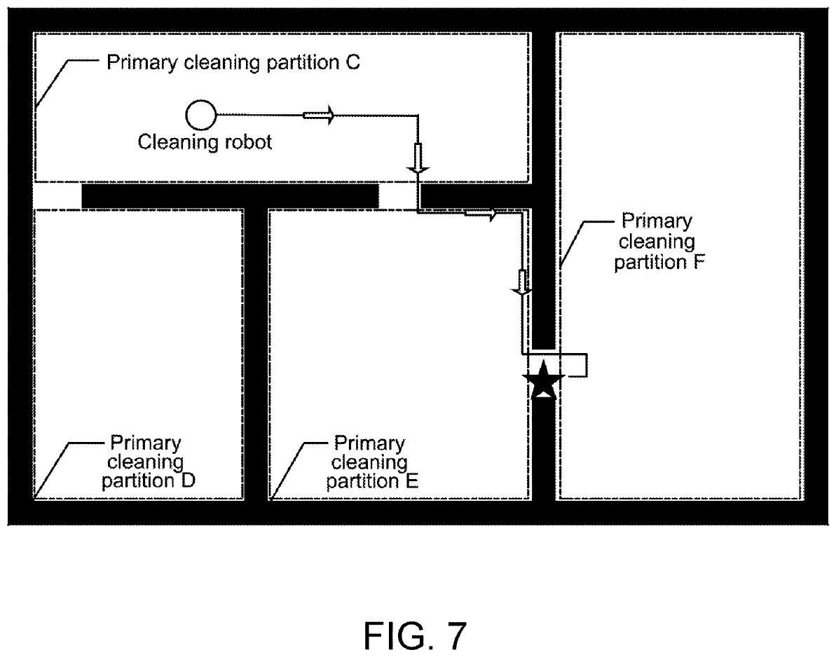

For example, when the length and width of the closed area are 13.2 meters and 10 meters, respectively, and the preset length and width are 5 meters and 3 meters, respectively, M1/N1=2.64, M2/N2=3.33, then K1=2, and K2=3. The closed area is cut 2 times in a length direction, that is, the closed area will be equally divided into 3 parts in the length direction of the closed area; similarly, the closed area is cut 3 times in a width direction of the closed area, that is, the closed area will be equally divided into 4 parts in the width direction of the closed area, and finally the closed area is divided into 12 primary cleaning partitions.
403: Determining whether a primary cleaning partition meeting a re-cleaning condition is present, if so, the primary cleaning partition meeting the re-cleaning condition is designated as a re-cleaning partition to obtain at least one re-cleaning partition, wherein the re-cleaning condition is that the primary cleaning partition is provided with an along-wall mark and is not filled up by a cleaning mark; and
there are three re-cleaning partition generation scenarios as follows:
1) When partition is performed by the cleaning robot, and a room is divided into different primary cleaning partitions, one of the primary cleaning partitions is subjected to an along-edge cleaning, wherein the doorway of the room is blocked by a dynamic obstacle during the cleaning process, so that the rest part of the room cannot be cleaned, but the cleaning robot has been to the room for cleaning. As shown in FIG. 5, the room 2 is divided into two different primary cleaning partitions, when the primary cleaning partition A is completely cleaned, the primary cleaning partition B of the room 2 has not been cleaned; however, the doorway is blocked, so that the cleaning robot cannot enter, and it cleans other areas first, consequently, the primary cleaning partition B of the room 2 is missed to be cleaned.
2) When a narrow area such as a doorway is included in the primary cleaning partition, a dynamic obstacle blocks the doorway after the cleaning robot performs along-edge cleaning in the current area, so that a part of areas in the primary cleaning partition are missed to be cleaned. As shown in FIG. 6, the doorway is blocked by the obstacle after the along-edge cleaning, consequently, an internal diagonal line area in the current primary cleaning partition is missed to be cleaned.
3) When the cleaning robot navigates, the cleaning robot has once passed an area along the edge, however, the area is missed to be cleaned because the doorway is blocked by an obstacle. As shown in FIG. 7, when the cleaning robot is in the primary cleaning partition C and wants to navigate to a certain point of the primary cleaning partition F, wherein a primary cleaning partition E is passed through, after the cleaning robot completes the cleaning of the primary cleaning partition F and then navigates to the primary cleaning partition E for cleaning, the doorways of the primary cleaning partition F and the primary cleaning partition E are blocked, so that the primary cleaning partition E is missed to be cleaned.

A cleaning mode of the cleaning robot includes along-edge cleaning and area cleaning. Herein, the along-edge cleaning refers to cleaning along an edge of a primary cleaning partition, and when the cleaning robot performs along-edge cleaning, the along-wall marks are added in the grid map at intervals of a preset time or a preset traveling distance. The area cleaning refers to cleaning in a zigzag path within an area surrounded by markings along the wall, when the cleaning robot performs area cleaning, the cleaning marks are added in the grid map at intervals of preset time or a preset traveling distance. The along-wall marks and the cleaning marks can be marks with two different colors or two different shapes. In each primary cleaning partition, the cleaning robot performs the along-edge cleaning first, followed by the area cleaning.

The cleaning robot scans each primary cleaning partition on the grid map, and if any one of the following three cases occurs in the primary cleaning partition, the primary cleaning partition is designating as a re-cleaning partition:
1) a part of edges of the primary cleaning partition are provided with along-wall marks;
2) all edges of the primary cleaning partition are provided with along-wall marks, however, the primary cleaning partition is not provided with cleaning marks; and
3) all edges of the primary cleaning partition are provided with along-wall marks, and the primary cleaning partition is provided with cleaning marks, however, the primary cleaning partition is not filled with the cleaning marks.

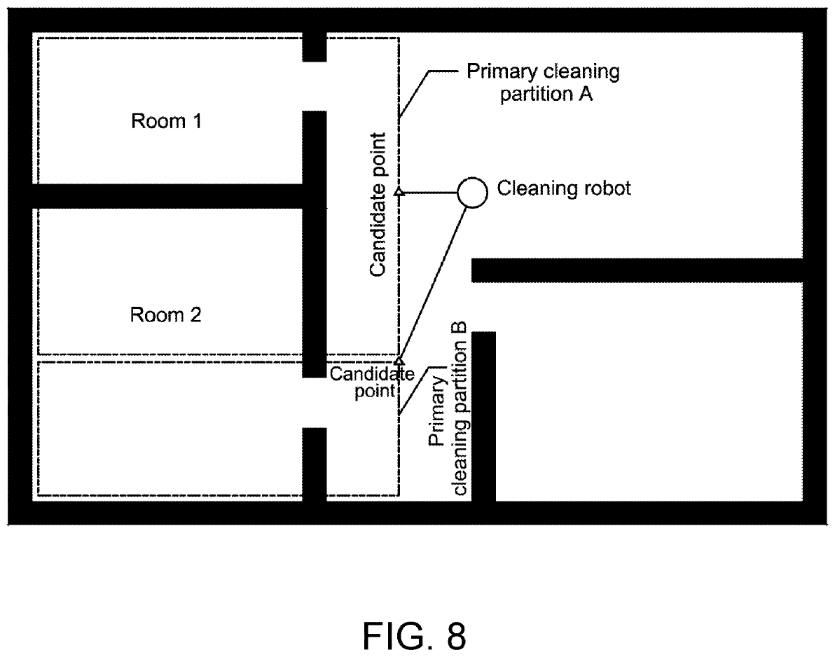

For example, the target area has 5 primary cleaning partitions, wherein only a part of edges of the primary cleaning partition 1 are provided with along-wall marks; all edges of the primary cleaning partition 2 are provided with along-wall marks, and this partition is filled with cleaning marks; all edges of the primary cleaning partition 3 are provided with along-wall marks, however, this partition is not provided with cleaning marks; a part of edges of the primary cleaning partition 4 are provided with along-wall marks, however, this partition is not filled with cleaning marks; and all edges of the primary cleaning partition 5 are provided with along-wall marks, however, this partition is not filled with cleaning marks. Therefore, the primary cleaning partition 1, the primary cleaning partition 3, the primary cleaning partition 4, and the primary cleaning partition 5 are designating as re-cleaning partitions.
404: Determining whether a re-cleaning partition that a cleaning robot can reach is present in the at least one re-cleaning partition according to a preset obstacle information database, wherein the obstacle information database is configured to record real-time obstacle information identified during the cleaning process; and
determining at least one candidate point according to a current position point of the cleaning robot, wherein the candidate point is a contour point with the shortest straight-line distance between the re-cleaning partition and the current position point; as shown in FIG. 8, planning a navigation route from the current position point to each candidate point to obtain at least one navigation route, invoking a preset obstacle information database to inquire real-time obstacle information on the at least one candidate navigation route, so as to obtain information of an obstacle with a state of “present”, determining whether at least one obstacle-free navigation route is present in the at least one candidate navigation route according to the obstacle information present on the at least one candidate navigation route, and if so, a re-cleaning partition corresponding to the at least one obstacle-free navigation route is designated as a re-cleaning partition that the cleaning robot can reach.

It should be additionally noted that there are three reasons for the re-cleaning partition, the first reason is that a dynamic obstacle is at an entrance; the second reason is that a low obstacle is near the entrance or on the edge, due to the hardware structure, the laser radar cannot identify the low obstacle, and the low obstacle is identified as an occupied area on the grid map, so that the entrance becomes smaller, resulting in the same situation as the third situation; and the third reason is that the entrance is narrow, and a size of the entrance is the same as or slightly larger than a diameter of the cleaning robot, due to a movement control error of the cleaning robot, sometimes the cleaning robot cannot pass through the entrance. When a candidate point of the re-cleaning partition is at an entrance, the cleaning robot reaches the entrance; and when the candidate point of the re-cleaning partition is at a non-entrance, the cleaning robot passes through the entrance, so that a necessary condition for determining whether the cleaning robot can reach the entrance of the re-cleaning partition is that there is no obstacle at the entrance of the re-cleaning partition. If the obstacle is present in the target candidate navigation route but it is not at the entrance, whether another obstacle-free navigation route is present between the cleaning robot and the target re-cleaning partition corresponding to the target candidate navigation route is determined again, and if so, this obstacle-free navigation route is taken as a new candidate navigation route of the target re-cleaning partition.

For example, the target area has 4 re-cleaning partitions: a re-cleaning partition 1, a re-cleaning partition 2, a re-cleaning partition 3, and a re-cleaning partition 4. The cleaning robot plans navigation routes to 4 re-cleaning partitions to obtain corresponding candidate navigation route 1, candidate navigation route 2, candidate navigation route 3, and candidate navigation route 4. A preset obstacle information database is invoked to inquire whether an obstacle is present on the 4 candidate navigation routes. After inquiry, an obstacle is absent on the candidate navigation route 1 and the candidate navigation route 2, and an obstacle is present on the candidate navigation route 3 and the candidate navigation route 4, however, the obstacle on the candidate navigation route 3 is at an entrance of the re-cleaning partition 3, and the obstacle on the candidate navigation route 4 is not at the entrance of the re-cleaning partition 4. The cleaning robot determines whether an obstacle-free navigation route to the re-cleaning partition 4 is present. After determination, an obstacle-free navigation route 4 is present, and the obstacle-free navigation route 4 is taken as a new candidate navigation route 4. Therefore, the re-cleaning partition 1, the re-cleaning partition 2, and the re-cleaning partition 4 are the re-cleaning partitions that the cleaning robot can reach.
405: If the re-cleaning partition that the cleaning robot can reach is present, navigating to a target partition, wherein the target partition is the re-cleaning partition that the cleaning robot can reach with the shortest distance; and
if the re-cleaning partition that the cleaning robot can reach is present, determining whether the re-cleaning partition that the cleaning robot can reach is unique; if the re-cleaning partition that the cleaning robot can reach is unique, the unique re-cleaning partition that the cleaning robot can reach is designated as a target partition, and navigating to the target partition; if the re-cleaning partition that the cleaning robot can reach is not unique, calculating a distance between a current position point of the cleaning robot and a candidate point of each re-cleaning partition, wherein there are various distance calculation modes, such as a Euclidean distance, a navigation distance, or a Manhattan distance. Preferably, the Manhattan distance between each candidate point and the cleaning robot is calculated herein to obtain at least one Manhattan distance, and the candidate point is a contour point with the shortest straight-line distance between the re-cleaning partition and the current position point; screening the shortest Manhattan distance from a plurality of candidate Manhattan distances; and determining a re-cleaning partition corresponding to the shortest Manhattan distance as a target partition, and navigating to the target partition.

Two candidate point selection modes are provided, where the first mode is that a cleaning robot is taken as a center, all points on a grid map are scanned by adopting a breadth first search (BFS) algorithm, and the first scanned point belonging to a target reachable re-cleaning partition is taken as a candidate point of the target reachable re-cleaning partition; and the second mode is that the cleaning robot sends out sound wave signals or light signals to a target reachable re-cleaning partition for detection, and a point corresponding to the first received feedback signals is taken as a candidate point of the target reachable re-cleaning partition.
406: When the navigation ends, determining whether the navigation is successful, wherein the successful navigation means that the cleaning robot reaches an end of the planned navigation route;
When the cleaning robot reaches an end according to the planned navigation route, the navigation ends, and the navigation is successful in this case; and when the cleaning robot encounters an obstacle during the navigation to the target partition, the navigation ends, and the navigation is unsuccessful in this case.
407: If the navigation is successful, controlling the cleaning robot to clean the target partition, wherein if the navigation is successful, it means that the cleaning robot is located in the target partition, then the target partition is cleaned, wherein there are two cleaning modes:
the first cleaning mode is as follows: an along-wall mark and a cleaning mark are searched in the target partition, when the cleaning mark is present in the target partition, the cleaning robot moves to an end position of the cleaning mark, and starts to perform area cleaning from the end position according to a zigzag path; when a complete along-wall mark is present in the target partition, the cleaning robot moves to a corner position, and starts to perform area cleaning along the wall from the corner position according to a zigzag path; and when a partial along-edge is present in the target partition, the cleaning robot moves to the end position of the along-wall mark, continues to perform along-edge cleaning from the end position, and performs area cleaning according to a zigzag path after the along-edge cleaning is completed.

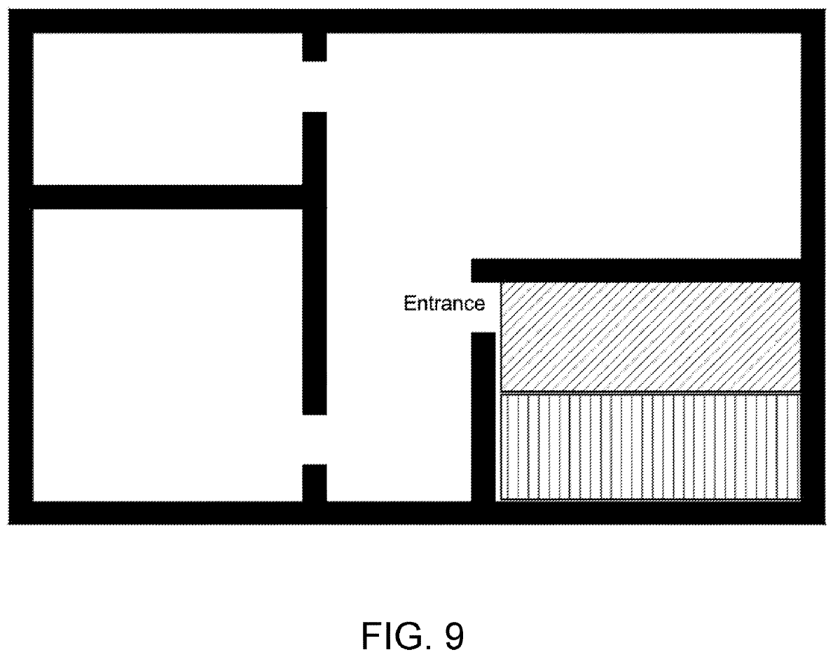

The second cleaning mode is as follows: an along-wall mark and a cleaning mark are searched in the target partition, for a part with the along-wall mark, an area cleaning is performed on the along-edge part to according to a zigzag path, wherein if after an area with the along-wall mark is cleaned, it is found that there are still un-cleaned parts in the current partition, then the along-edge cleaning is performed on the un-cleaned part first, and then the area cleaning is performed on the along-edge part according to a zigzag path. As shown in FIG. 9, the missed cleaning area includes a part of a diagonal line box on which an along-edge cleaning has been performed and a part of a vertical line box on which the along-edge cleaning has not been performed. If the cleaning robot can enter the missed cleaning area from entrance, the cleaning robot will firstly perform the zigzag area cleaning on the diagonal line box area on which the along-edge cleaning has been performed, and after the cleaning of the diagonal line box area is completed, the along-edge cleaning is performed on the vertical line box area, and then the area cleaning is performed according to a zigzag path.

After the cleaning of the target area is completed, returning to step 204 to determine whether there is any re-cleaning partition that the cleaning robot can reach, if so, selecting the next target partition, and if not, ending the cleaning ends.
408: If the navigation is unsuccessful, determining whether the cleaning robot is located in the target partition, if so, controlling the cleaning robot to clean the target partition, and if not, selecting a target partition again or ending the cleaning.

It should be additionally noted that the cleaning robot itself has a certain size, and in order to improve the cleaning efficiency, when a part of the cleaning robot enters the target partition, it is equivalent to that the cleaning robot is located in the target partition, therefore, a rule for determining whether the cleaning robot is located in the target partition is added as follows:
radiating and expanding the target partition by N grids, wherein N is a preset positive integer value, so as to obtain a target expanded partition; if the cleaning robot is completely located in the target expanded partitions, determining that the cleaning robot is located in the target partitions and cleans the target partitions, wherein the cleaning mode is as described in step 207 and details are not described herein again; and if the cleaning robots are not completely located in the target expansion partition, returning to step 204, determining whether a re-cleaning partition that the cleaning robot can reach is present, if so, selecting a next target partition, and if not, ending the cleaning.

In embodiments of the present disclosure, a partition that needs re-cleaning is identified from a primary cleaning partition according to the re-cleaning condition, so that a missed area that has not been cleaned yet is avoided; the latest state of the obstacle is ensured by maintaining the obstacle information database; a re-cleaning partition that the cleaning robot can reach and is closest to the cleaning robot is selected, so that the cleaning efficiency is improved; the result of navigating of the cleaning robot to the re-cleaning partition is determined, and the operations of cleaning, selecting a next re-cleaning partition or ending the cleaning are performed according to the determination result, so as to complete the cleaning of the re-cleaning partition to the maximum extent, and improve the cleaning quality of the target area.

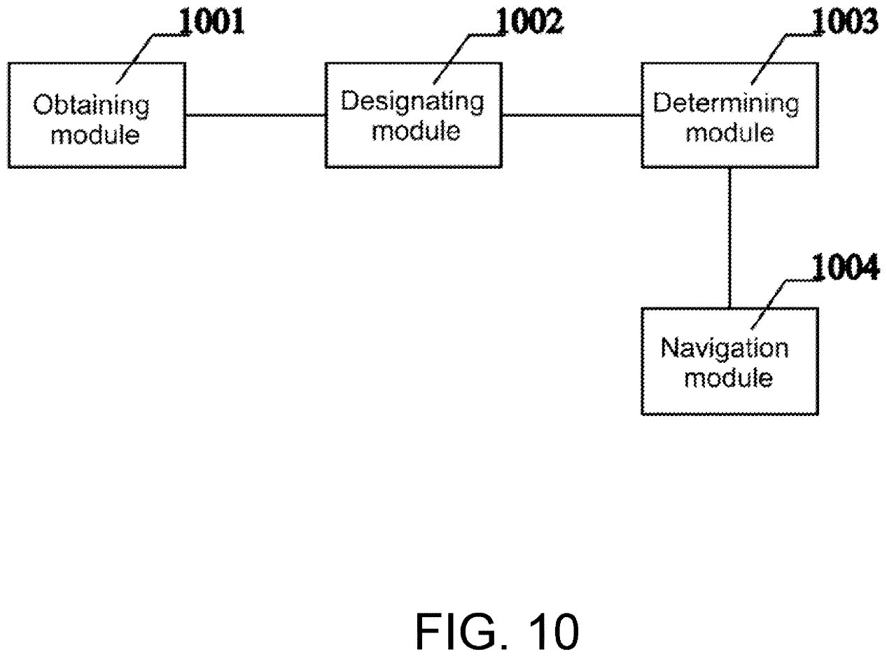

The method of re-cleaning according to an embodiment of the present disclosure is described above, and an apparatus of re-cleaning according to an embodiment of the present disclosure is described below. Referring to FIG. 10, an embodiment of an apparatus of re-cleaning according to an embodiment of the present disclosure includes:
an obtaining module 1001, configured to obtain a grid map of a target area, wherein the grid map includes at least one primary cleaning partition;
a designating module 1002, configured to determine whether a primary cleaning partition meeting a re-cleaning condition is present, if so, designate the primary cleaning partition meeting the re-cleaning condition as a re-cleaning partition to obtain at least one re-cleaning partition, wherein the re-cleaning condition is that the primary cleaning partition is provided with an along-wall mark and is not filled up by a cleaning mark;
a determining module 1003, configured to determine whether a re-cleaning partition that a cleaning robot can reach is present in the at least one re-cleaning partition according to a preset obstacle information database, wherein the obstacle information database is configured to record real-time obstacle information identified during the cleaning process; and
a navigation module 1004, configured to navigate to a target partition for cleaning if the re-cleaning partition that the cleaning robot can reach is present, wherein the target partition is the re-cleaning partition that the cleaning robot can reach with the shortest distance.

In embodiments of the present disclosure, a partition that needs re-cleaning is identified from a primary cleaning partition according to the re-cleaning condition, so that a missed area that has not been cleaned yet is avoided, and a re-cleaning partition that the cleaning robot can reach and is closest to the cleaning robot is selected, so that the cleaning efficiency is improved; and the cleaning robot performs the area cleaning after reaching the re-cleaning partition, so that the cleaning quality of the target area is improved.

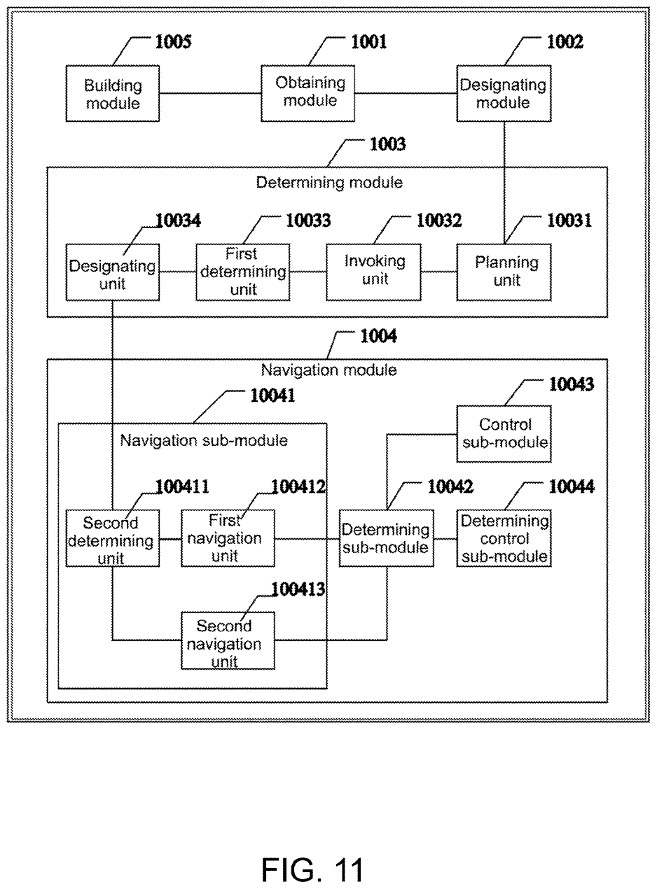

Referring to FIG. 11, another embodiment of an apparatus of re-cleaning according to an embodiment of the present disclosure includes:
an obtaining module 1001, configured to obtain a grid map of a target area, wherein the grid map includes at least one primary cleaning partition;
a designating module 1002, configured to determine whether a primary cleaning partition meeting a re-cleaning condition is present, if so, designate the primary cleaning partition meeting the re-cleaning condition as a re-cleaning partition to obtain at least one re-cleaning partition, wherein the re-cleaning condition is that the primary cleaning partition is provided with an along-wall mark and is not filled up by a cleaning mark;
a determining module 1003, configured to determine whether a re-cleaning partition that a cleaning robot can reach is present in the at least one re-cleaning partition according to a preset obstacle information database, wherein the obstacle information database is configured to record real-time obstacle information identified during the cleaning process; and
a navigation module 1004, configured to navigate to a target partition for cleaning if the re-cleaning partition that the cleaning robot can reach is present, wherein the target partition is the re-cleaning partition that the cleaning robot can reach with the shortest distance.

In some embodiments, the determining module 1003 includes:
a planning unit 10031, configured to plan a navigation route from the cleaning robot to each re-cleaning partition in the at least one re-cleaning partition, so as to obtain at least one candidate navigation route;
an invoking unit 10032, configured to invoke the preset obstacle information database to inquire the real-time obstacle information on the at least one candidate navigation route;
a first determining unit 10033, configured to determine whether at least one obstacle-free navigation route is present in the at least one candidate navigation route according to the real-time obstacle information present on the at least one candidate navigation route; and
a determining unit 10034, configured to determine, if the re-cleaning partition is present, a re-cleaning partition corresponding to the at least one obstacle-free navigation route as a re-cleaning partition that the cleaning robot can reach.

In some embodiments, the planning unit 10031 is specifically configured to:
determine at least one candidate point according to a current position point of the cleaning robot, wherein the candidate point is a contour point with the shortest straight-line distance between the re-cleaning partition and the current position point; and plan a navigation route from the current position point to each candidate point to obtain at least one navigation route.

In some embodiments, the navigation module 1004 includes:
a navigation sub-module 10041, configured to navigate to a target partition if the re-cleaning partition that the cleaning robot can reach is present;
a determining sub-module 10042, configured to determine whether the navigation is successful when the navigation ends, wherein the navigation is successful means that the cleaning robot reaches an end of the planned navigation route;
a control sub-module 10043, configured to control the cleaning robot to clean the target partition if the navigation is successful; and
a determining control sub-module 10044, configured to determine, if the navigation is unsuccessful, whether the cleaning robot is located in the target partition, if so, control the cleaning robot to clean the target partition, and if not, select a target partition again or end the cleaning.

In some embodiments, the navigation sub-module 10041 includes:
a second determining unit 100411, configured to determine, if the re-cleaning partition that the cleaning robot can reach is present, whether the re-cleaning partition that the cleaning robot can reach is unique;
a first navigation unit 100412, configured to designate the unique re-cleaning partition that the cleaning robot can reach as a target partition and navigate to the target partition if the re-cleaning partition that the cleaning robot can reach is unique; and
a second navigation unit 100413, configured to designate a re-cleaning partition closest to the cleaning robot as a target partition and navigate to the target partition if the re-cleaning partition that the cleaning robot can reach is not unique.

In some embodiments, the second navigation unit 100413 is specifically configured to:
if the re-cleaning partition that the cleaning robot can reach is not unique, calculate a Manhattan distance between the current position point of the cleaning robot and a candidate point of each re-cleaning partition, so as to obtain at least one candidate Manhattan distance, wherein the candidate point is a contour point with the shortest straight-line distance between the re-cleaning partition and the current position point; screen the shortest Manhattan distance from a plurality of candidate Manhattan distances; and designate a re-cleaning partition corresponding to the shortest Manhattan distance as a target partition, and navigate to the target partition.

In some embodiments, the apparatus of re-cleaning further includes a building module 1005, wherein the building module 1005 is specifically configured to:
establish an obstacle information database, wherein the obstacle information database configured to record real-time obstacle information identified by the cleaning robot during the cleaning process, and the obstacle information includes a position of an obstacle, a picture of an obstacle, a surrounding environment picture of an obstacle, and a state of an obstacle; when the cleaning robot identifies a newly added obstacle, add information of the newly added obstacle to the obstacle information database; and when the cleaning robot identifies that a position of a target obstacle recorded in the obstacle information database has changed, update information of the target obstacle in the obstacle information database.

In embodiments of the present disclosure, a partition that needs re-cleaning is identified from a primary cleaning partition according to the re-cleaning condition, so that a missed area that has not been cleaned yet is avoided; the latest state of the obstacle is ensured by maintaining the obstacle information database; a re-cleaning partition that the cleaning robot can reach and is closest to the cleaning robot is selected, so that the cleaning efficiency is improved; the result of navigating of the cleaning robot to the re-cleaning partition is determined, and the operations of cleaning, selecting a next re-cleaning partition or ending the cleaning are performed according to the determination result, so as to complete the cleaning of the re-cleaning partition to the maximum extent, and improve the cleaning quality of the target area.

The above FIG. 10 and FIG. 11 describe the apparatus of re-cleaning according to an embodiment of the present disclosure in detail from a perspective of a modular functional entity, and the following describes the cleaning robot according to an embodiment of the present disclosure in detail from a perspective of hardware processing.

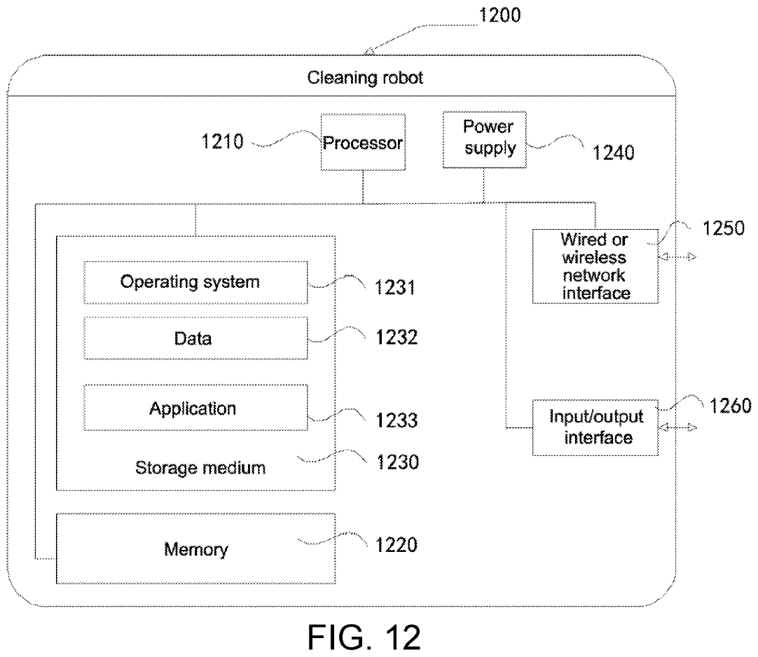

FIG. 12 is a schematic diagram of a structure of a cleaning robot according to an embodiment of the present disclosure. The cleaning robot 1200 may have a relatively large difference due to different configurations or performance, and may include one or more central processing units (CPU) 1210 (for example, one or more processors) and a memory 1220, and one or more storage media 530 (for example, one or more mass storage devices) that store an application program 1233 or data 1232. Herein, the memory 1220 and the storage medium 1230 may perform transitory storage or persistent storage. A program stored in the storage medium 1230 may include one or more modules (not shown in the figure), and each module may include a series of instruction operations for the cleaning robot 1200. Still further, the central processing unit 1210 may be configured to communicate with the storage medium 1230, and perform, on the cleaning robot 1200, the series of instruction operations in the storage medium 1230.

The cleaning robot 1200 may further include one or more power supplies 1240, one more wired or wireless network interfaces 1250, one or more input/output interfaces 1260, and/or one or more operating systems 1231, such as Windows Serve, Mac OS X, Unix, Linux, and FreeBSD. Those skilled in the art can understand that the structure of the cleaning robot shown in FIG. 12 does not constitute any limitation on the cleaning robot, and the cleaning robot may include more or fewer components than those shown in the figure, or have some components combined, or have different arrangements of components.

The present disclosure further provides a computer device, wherein the computer device includes a memory and a processor, the memory stores computer readable instructions, and the computer readable instructions, when executed by the processor, make the processor perform the steps of the method of re-cleaning in the above embodiments.

The present disclosure further provides a computer-readable storage medium, wherein the computer-readable storage medium may be a non-volatile computer-readable storage medium and may also be a volatile computer-readable storage medium, and the computer-readable storage medium stores instructions, wherein the instructions, when run on a computer, makes the computer perform the steps of the method of re-cleaning.

It may be clearly understood by those skilled in the art that, for the purpose of convenient and brief description, for a detailed working process of the foregoing systems, apparatuses, and units, reference can be made to a corresponding process in the foregoing method embodiments, and details are not described herein again.

When the integrated unit is implemented in the form of the software functional unit and sold or used as an independent product, it may be stored in a computer-readable storage medium. Based on such an understanding, the technical solutions of the present disclosure in essence, or the part contributing to a conventional technology, or all or part of the technical solutions may be implemented in the form of a software product, and the computer software product is stored in a storage medium and includes several instructions for making a computer device (which may be a personal computer, a server, a network device, or the like) to perform all or a part of the steps of the methods described in embodiments of the present disclosure. The foregoing storage medium includes any medium that can store program code, for example, a USB flash drive, a removable hard disk, a read-only memory (ROM), a random access memory (RAM), a floppy disk, or a compact disc.

The foregoing embodiments are merely intended for describing the technical solutions of the present disclosure other than limiting the present disclosure. Although the present disclosure is described in detail with reference to the foregoing embodiments, those ordinary skilled in the art should understand that they may still make modifications to the technical solutions described in the foregoing embodiments or make equivalent replacements to some technical features thereof, without departing from the spirit and scope of the technical solutions of embodiments of the present disclosure.

What is claimed is:

1. A method of re-cleaning, applied to a cleaning robot, comprising:
obtaining a grid map of a target area, wherein the grid map comprises at least one primary cleaning partition;
based on real-time obstacle information and the grid map, obtaining a target partition, wherein the target partition is a re-cleaning partition accessible to the cleaning robot, and the re-cleaning partition is a primary cleaning partition that is incompletely cleaned; and
navigating the cleaning robot to the target partition for cleaning.

2. The method of re-cleaning according to claim 1, wherein the navigating the cleaning robot to the target partition for cleaning comprises:
determining at least one candidate point according to a current position point of the cleaning robot, wherein each candidate point is a contour point with a shortest straight-line distance between each re-cleaning partition and the current position point;
planning a navigation route from the current position point to each candidate point, so as to obtain at least one candidate navigation route;
determining whether at least one obstacle-free navigation route is present in the at least one candidate navigation route according to the real-time obstacle information on the at least one candidate navigation route;
determining a re-cleaning partition corresponding to the at least one obstacle-free navigation route as a re-cleaning partition that the cleaning robot is capable of reaching in a condition that the at least one obstacle-free navigation route is present; and
navigating the cleaning robot to the target partition for cleaning according to an obstacle-free navigation route corresponding to the target partition.

3. The method of re-cleaning according to claim 1, wherein the navigating the cleaning robot to the target partition for cleaning comprises:
determining whether navigation is successful when the navigation ends, wherein the navigation is successful means that the cleaning robot reaches an end of a planned navigation route;
controlling the cleaning robot to clean the target partition in a condition that the navigation is successful;
determining whether the cleaning robot is located in the target partition in a condition that the navigation is unsuccessful;
controlling the cleaning robot to clean the target partition in a condition that the cleaning robot is located in the target partition; and
selecting a target partition again or ending cleaning in a condition that the cleaning robot is not located in the target partition.

4. The method of re-cleaning according to claim 3, wherein the determining whether the cleaning robot is located in the target partition comprises:
expanding the target partition by pre-set number of grids; and
determining the cleaning robot is located in the target partition in a condition that the cleaning robot is completely located in the expanded target partition.

5. The method of re-cleaning according to claim 1, wherein a cleaning mode of the cleaning robot comprises an along-edge cleaning and an area cleaning, the along-edge cleaning is defined as cleaning along an edge of a specific primary cleaning partition, and the area cleaning is defined as cleaning within an area surrounded by the edge of the specific primary cleaning partition;
the target partition is the re-cleaning partition accessible to the cleaning robot with a shortest distance from a current position of the cleaning robot; and
the re-cleaning partition is the primary cleaning partition where part of the edge cleaning or the area cleaning is not completed.

6. The method of re-cleaning according to claim 5, wherein the navigating the cleaning robot to the target partition for cleaning comprises:
controlling the cleaning robot to move to an end position of the area surrounded by the edge of the specific primary cleaning partition in a condition that part of the area cleaning is not performed; and
performing the area cleaning from the end position according to a zigzag path.

7. The method of re-cleaning according to claim 5, wherein the navigating the cleaning robot to the target partition for cleaning comprises:
controlling the cleaning robot to move to a corner position of the target partition in a condition that the edge cleaning is performed and the area cleaning is not performed; and
performing the area cleaning on the area surrounded by the edge of the specific primary cleaning partition according to a zigzag path.

8. The method of re-cleaning according to claim 5, wherein the navigating the cleaning robot to the target partition for cleaning comprises:
controlling the cleaning robot to move to an end position of the edge of the specific primary cleaning partition in a condition that the part of the edge cleaning is not performed; and
continuing to perform the along-edge cleaning from the end position of the edge of the specific primary cleaning partition; and
performing the area cleaning according to a zigzag path after the along-edge cleaning is completed.

9. The method of re-cleaning according to claim 5, wherein the navigating the cleaning robot to the target partition for cleaning comprises:
performing an area cleaning on a first part of the target partition where the edge cleaning is completed according to a zigzag path;
performing an edge cleaning on a second part of the target partition in a condition that the second part is a part on which neither the along-edge cleaning nor the area cleaning is performed; and
performing the area cleaning on the second part of the target partition according to the zigzag path.

10. The method of re-cleaning according to claim 1, wherein the obtaining the target partition comprises:
determining whether the re-cleaning partition that the cleaning robot is capable of reaching is unique in a condition that the re-cleaning partition that the cleaning robot is capable of reaching is present;
designating the unique re-cleaning partition that the cleaning robot is capable of reaching as the target partition; and
designating a re-cleaning partition closest to the cleaning robot as the target partition in a condition that the re-cleaning partition that the cleaning robot is capable of reaching is not unique.

11. The method of re-cleaning according to claim 10, wherein the designating the re-cleaning partition closest to the cleaning robot as the target partition comprises:
calculating a Manhattan distance between a current position point of the cleaning robot and a candidate point of each re-cleaning partition, so as to obtain a plurality of candidate Manhattan distances, wherein the candidate point is a contour point with the shortest straight-line distance between the re-cleaning partition and the current position point;
screening the shortest Manhattan distance from the candidate Manhattan distances; and
designating a re-cleaning partition corresponding to the shortest Manhattan distance as the target partition.

12. The method of re-cleaning according to claim 1, wherein before the obtaining the grid map of the target area, the method comprises:
establishing an obstacle information database, wherein the obstacle information database is configured to record the real-time obstacle information identified by the cleaning robot during the cleaning process;
adding information of a newly added obstacle to the obstacle information database when the cleaning robot identifies the newly added obstacle; and
updating information of a target obstacle in the obstacle information database when the cleaning robot identifies that a position of the target obstacle that has been recorded in the obstacle information database changes.

13. A cleaning robot, comprising: a memory and at least one processor, wherein the memory stores instructions; and
the at least one processor invokes the instructions in the memory, so as to make the cleaning robot perform the method of re-cleaning according to claim 1.

14. The cleaning robot according to claim 13, wherein the based on real-time obstacle information and the grid map, navigating the cleaning robot to the target partition for cleaning comprises:
determining at least one candidate point according to a current position point of the cleaning robot, wherein each candidate point is a contour point with a shortest straight-line distance between each re-cleaning partition and the current position point;
planning a navigation route from the current position point to each candidate point, so as to obtain at least one candidate navigation route;
determining whether at least one obstacle-free navigation route is present in the at least one candidate navigation route according to the real-time obstacle information on the at least one candidate navigation route;
determining a re-cleaning partition corresponding to the at least one obstacle-free navigation route as a re-cleaning partition that the cleaning robot is capable of reaching in a condition that the at least one obstacle-free navigation route is present; and
navigating the cleaning robot to the target partition for cleaning according to an obstacle-free navigation route corresponding to the target partition.

15. The cleaning robot according to claim 13, wherein the navigating the cleaning robot to the target partition for cleaning comprises:
determining whether navigation is successful when the navigation ends, wherein the navigation is successful means that the cleaning robot reaches an end of a planned navigation route;
controlling the cleaning robot to clean the target partition in a condition that the navigation is successful;
determining whether the cleaning robot is located in the target partition in a condition that the navigation is unsuccessful;
controlling the cleaning robot to clean the target partition in a condition that the cleaning robot is located in the target partition; and
selecting a target partition again or ending cleaning in a condition that the cleaning robot is not located in the target partition.

16. The cleaning robot according to claim 15, wherein the determining whether the cleaning robot is located in the target partition comprises:
expanding the target partition by pre-set number of grids; and
determining the cleaning robot is located in the target partition in a condition that the cleaning robot is completely located in the expanded target partition.

17. The cleaning robot according to claim 13, wherein a cleaning mode of the cleaning robot comprises an along-edge cleaning and an area cleaning, the along-edge cleaning is defined as cleaning along an edge of a specific primary cleaning partition, and the area cleaning is defined as cleaning within an area surrounded by the edge of the specific primary cleaning partition;
the target partition is the re-cleaning partition accessible to the cleaning robot with a shortest distance from a current position of the cleaning robot; and
the re-cleaning partition is the primary cleaning partition where part of the edge cleaning or the area cleaning is not completed.

18. The cleaning robot according to claim 17, wherein the navigating the cleaning robot to the target partition for cleaning comprises:
controlling the cleaning robot to move to an end position of the area surrounded by the edge of the specific primary cleaning partition in a condition that part of the area cleaning is not performed; and
performing the area cleaning from the end position according to a zigzag path.

19. The cleaning robot according to claim 17, wherein the navigating the cleaning robot to the target partition for cleaning comprises:
controlling the cleaning robot to move to a corner position of the target partition in a condition that the edge cleaning is performed and the area cleaning is not performed; and
performing the area cleaning on the area surrounded by the edge of the specific primary cleaning partition according to a zigzag path.

20. The cleaning robot according to claim 13, wherein the obtaining the target partition comprises:
determining whether the re-cleaning partition that the cleaning robot is capable of reaching is unique in a condition that the re-cleaning partition that the cleaning robot is capable of reaching is present;
designating the unique re-cleaning partition that the cleaning robot is capable of reaching as the target partition; and
designating a re-cleaning partition closest to the cleaning robot as the target partition in a condition that the re-cleaning partition that the cleaning robot is capable of reaching is not unique;
wherein the designating the re-cleaning partition closest to the cleaning robot as the target partition comprises:
calculating a Manhattan distance between a current position point of the cleaning robot and a candidate point of each re-cleaning partition, so as to obtain a plurality of candidate Manhattan distances, wherein the candidate point is a contour point with the shortest straight-line distance between the re-cleaning partition and the current position point;
screening the shortest Manhattan distance from the candidate Manhattan distances; and
designating a re-cleaning partition corresponding to the shortest Manhattan distance as the target partition.
